(19) United States
(12) Patent Application Publication
(10) Pub. No.: US 2012/0139678 A1
(43) Pub. Date: Jun. 7, 2012

(54) Non-Linear Transformer with Improved Construction and Method of Manufacturing the Same

(75) Inventors: Samuel S. Outten, Wytheville, VA (US); Thomas A. Hartmann, Wytheville, VA (US); Charles W. Johnson, Wytheville, VA (US)

(73) Assignee: ABB TECHNOLOGY AG, Zurich (CH)

(21) Appl. No.: 13/308,998

(22) Filed: Dec. 1, 2011

Related U.S. Application Data
(60) Provisional application No. 61/419,563, filed on Dec. 3, 2010.

(51) Int. Cl. H01F 30/12; H01F 41/00

(52) U.S. Cl. 336/5; 29/605

(57) ABSTRACT

A three-phase non-linear transformer and a method of constructing the same. The non-linear transformer includes a non-linear ferromagnetic core having a plurality of frames, each of which has a closed or substantially closed periphery. The frames are arranged to form at least three legs. A low voltage winding is formed around each leg and a high voltage winding is formed around each low voltage winding. Each high voltage winding includes a plurality of serially-connected disc windings. Each of the disc windings is formed of alternating concentric layers of a conductor strip and an insulation strip, wherein the conductor strip having a width to thickness ratio of greater than 10:1. A casing encapsulates each pair of high voltage and low voltage windings. The casing is formed using a mold at least partially formed by a winding device used to wind the high voltage and low voltage windings.

### CROSS REFERENCE TO RELATED APPLICATION

This application claims the benefit of U.S. provisional patent application No. 61/419,563 filed on Dec. 3, 2010, which is hereby incorporated by reference in its entirety.

### BACKGROUND OF THE INVENTION

This present invention relates to transformers and more particularly to non-linear transformers.

A conventional linear transformer comprises a core having a plurality of legs arranged in a line. An example of a linear transformer is a so-called E-core transformer having a core comprising a bottom yoke with three spaced-apart legs arranged in a line and extending upward therefrom. For a three phase application, three coils (one for each phase) are formed on a mandrel and then mounted to the legs, respectively. A top yoke is then secured across the tops of the legs.

Non-linear transformers have been known for a long period of time, but there has not been significant interest in them until more recently. A non-linear transformer has a plurality of legs that are not arranged in a line. The most common example of a non-linear transformer is a so-called delta or triangular transformer having three sections or frames that are arranged in a delta or triangular configuration. Each frame is typically closed and has two opposing leg sections and two opposing yoke sections. The frames are arranged such that the leg sections of each frame abut leg sections of the other two frames, respectively, thereby forming three legs with each leg formed by two abutting leg sections. The three legs are arranged in a triangular or delta configuration.

Since the frames of a non-linear transformer are closed, coils are typically formed on the legs of the core. The high voltage winding of each coil is formed from rectangular wire, which must be insulated prior to winding using insulation wrapping or enamel. A winding formed from rectangular wire also requires additional insulation to be placed between each winding layer. Moreover, the windings are formed using a pagoda or pyramid technique wherein the width of the layers decreases as the winding progresses radially outward. Such a winding technique requires the base layer to be rather wide, which can result in increased electrical stresses and, thus, greater insulation requirements.

It would therefore be desirable to provide a non-linear transformer that is easier to manufacture and has an improved construction. The present invention is directed to such a non-linear transformer and a method for manufacturing the same.

### SUMMARY OF THE INVENTION

In accordance with the present invention, a three-phase non-linear transformer is provided and includes a ferromagnetic core having three or more legs arranged in a non-linear configuration. Coil assemblies are mounted to the legs, respectively. Each of the coil assemblies includes a low voltage winding and a high voltage winding having a plurality of serially-connected disc windings. Each of the disc windings includes alternating concentric layers of one or more conductor strips and one or more insulation strip. The conductor strip has a width to thickness ratio of greater than 10:1. A casing encapsulates the high voltage winding. The casing is formed of a dielectric polymeric material.

Also provided in accordance with the present invention is a method of constructing a three-phase non-linear transformer. In accordance with the method, a non-linear ferromagnetic core is provided and includes a plurality of frames, each of which has a closed or substantially closed periphery. The frames are arranged to form at least three legs. For each leg of the core, a low voltage winding is formed around the leg. A high voltage winding is formed around each low voltage winding. The forming of each high voltage winding around its associated low voltage winding includes providing one or more insulation strips; providing one or more conductor strips, each having a width to thickness ratio of greater than 10:1; and winding the one or more insulation strips and the one or more conductor strips around the low voltage winding to form a plurality of disc windings arranged in an axial direction of the low voltage winding, wherein each of the disc windings comprises alternating concentric layers of the insulation strip and the conductor strip. Each high voltage winding is cast in a dielectric polymeric material.

### BRIEF DESCRIPTION OF THE DRAWINGS

The features, aspects, and advantages of the present invention will become better understood with regard to the following description, appended claims, and accompanying drawings where:

FIG. 1 is a top perspective view of a portion of a non-linear transformer embodied in accordance with the present invention;

FIG. 2 shows a side elevational view of a portion of the non-linear transformer;

FIG. 3 shows a perspective view of a frame of a core of the non-linear transformer;

FIG. 4 shows a top perspective view of the core, with portions thereof removed;

FIG. 5 shows a portion of a winding device mounted to a leg of the core;

FIG. 6 shows a gear assembly of the winding device, while the winding device is mounted to a leg of the core;

FIG. 7 shows the gear assembly of the winding device;

FIG. 8 shows a sectional view of a portion of a disc winding of a high voltage winding of the non-linear transformer;

FIG. 9 shows high voltage windings of the non-linear transformer enclosed in molds and being cast in an insulating polymeric material; and

FIG. 10 shows a high voltage winding encased in a casing, with the high voltage winding being shown in phantom.

### DETAILED DESCRIPTION OF ILLUSTRATIVE EMBODIMENTS

It should be noted that in the detailed description that follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

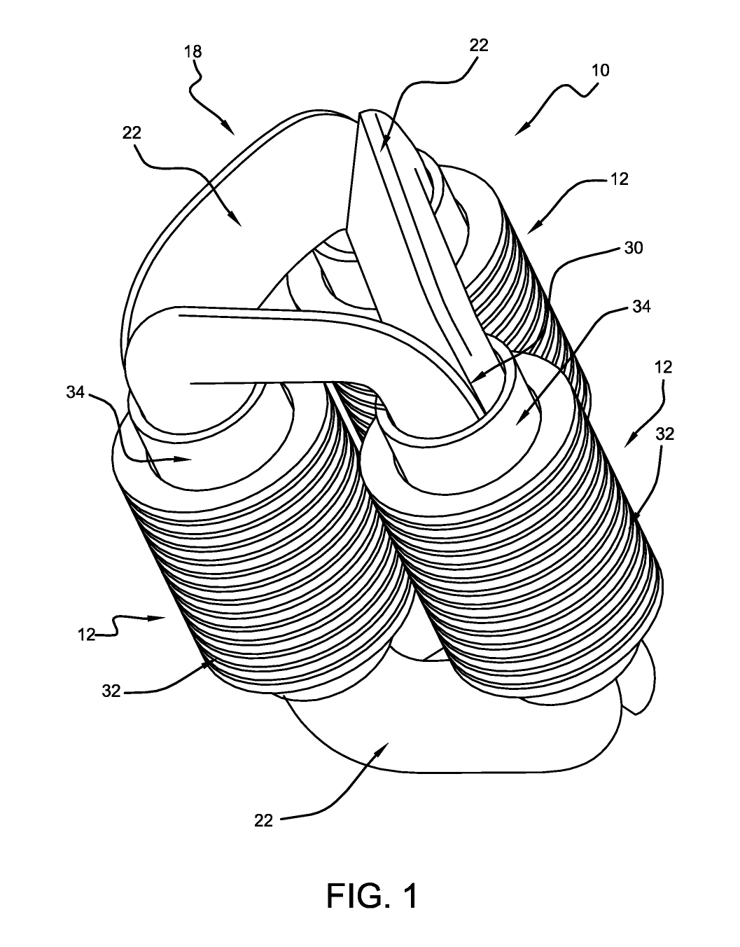

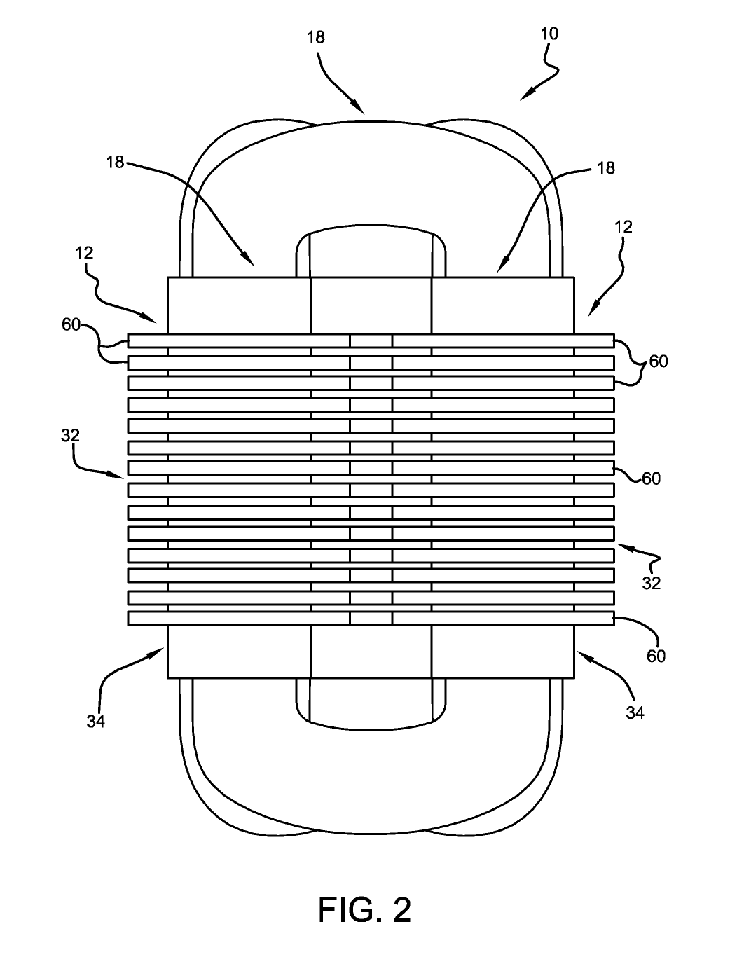

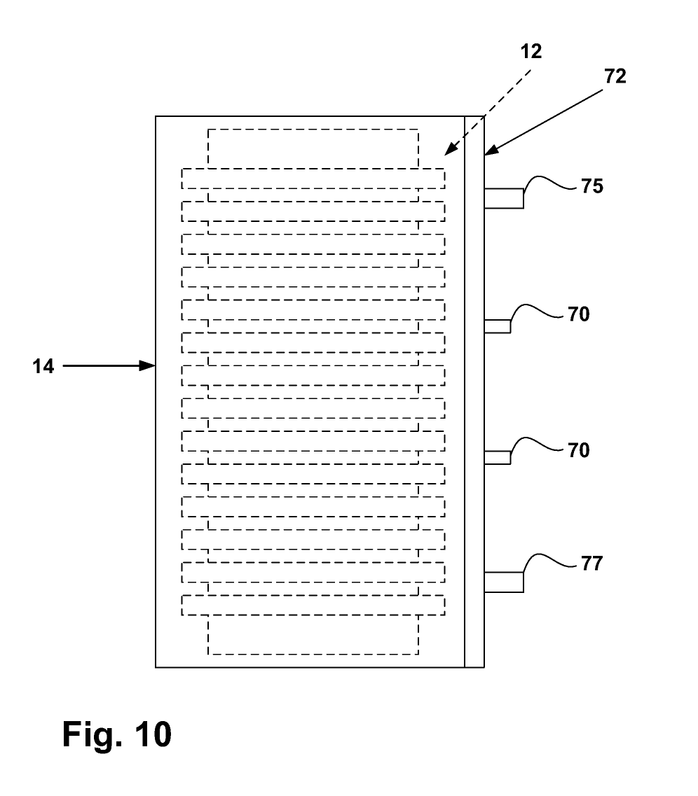

Referring now to FIGS. 1 and 2, there is shown a portion of a non-linear, three-phase dry transformer 10 constructed in accordance with the present invention. The transformer 10 generally comprises three coil assemblies 12 (one for each phase) mounted to a non-linear core 18, all of which may be enclosed within a ventilated outer housing (not shown). Each coil assembly 12 is encased in a casing 14 (shown in FIG. 10) comprised of one or more dielectric polymers.

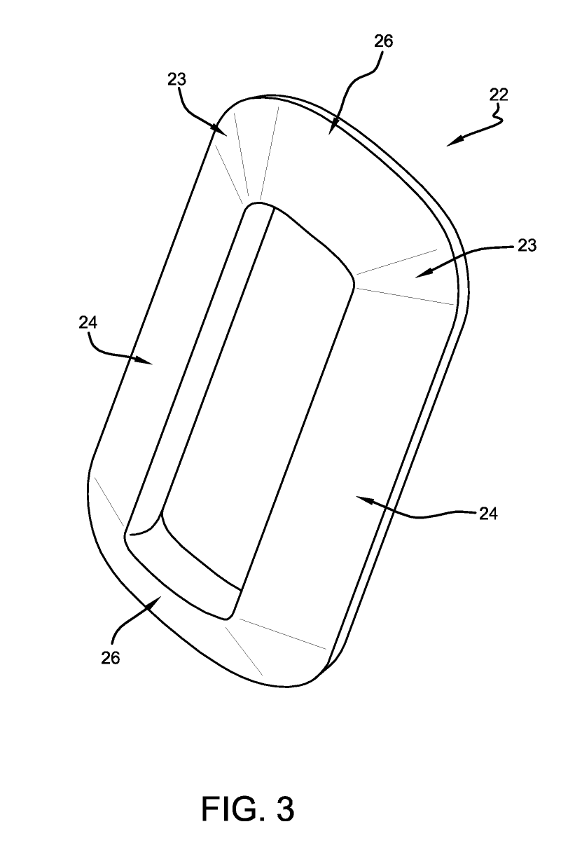

The core 18 is delta-shaped and comprises three frames 22, each of which has a closed or substantially closed periphery and an enlarged opening. As best shown in FIG. 3, each frame 22 has a rounded rectangular shape and includes a pair of opposing leg sections 24 joined by shoulders 23 to a pair of yoke sections 26, respectively. The leg sections 24 are significantly longer than the yoke sections 26.

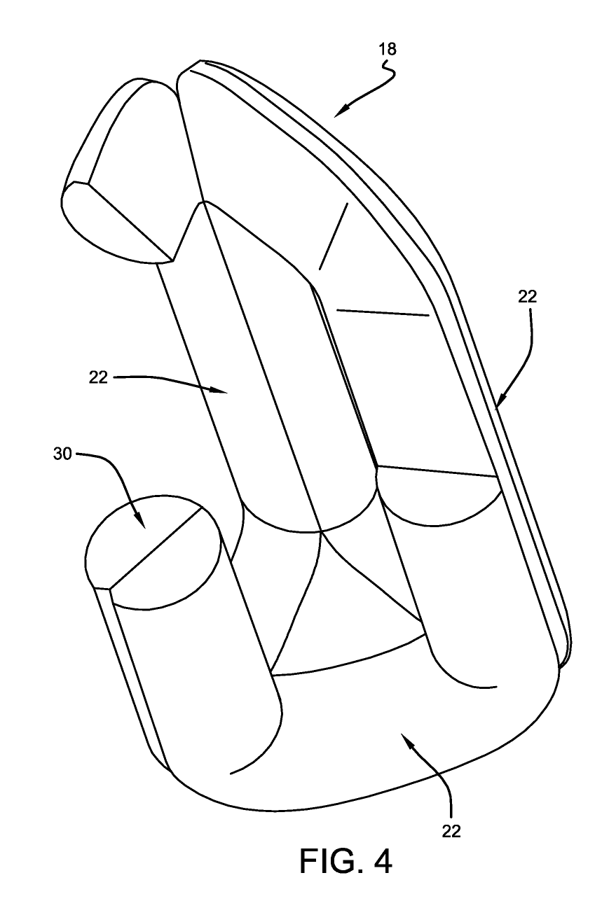

Each frame 22 is wound from one or more strips of metal, which may be silicon steel and/or amorphous metal. The one or more metal strips may be dimensioned and/or arranged to provide the frame 22 with a generally semi-circular cross-section, with an arcuate portion of the frame 22 facing inward and forward and a planar portion of the frame 22 facing outward and rearward, as best shown in FIG. 4. This configuration of the frame 22 may be formed in a number of different ways. For example, the one or more metal strips may be cut in a continuously tapered manner so as to have different widths in the different layers of the frame 22 and may be skewed or staggered. Once the winding of the one or more metal strips to form the frame 22 is completed, the one or more metal strips may be annealed. In addition, the frame 22 may be coated with one or more layers of coatings to protect the frame 22 from corrosion and/or to insulate the frame 22. Still further the leg sections 24 and yoke sections 26 (but excluding the shoulder sections in-between) may be wrapped in a dielectric tape.

The frames 22 are arranged in a triangle or delta configuration such that the leg sections 24 of each frame 22 abut leg sections 24 of the other two frames 22, respectively, thereby forming three legs 30 with each leg 30 formed by two abutting leg sections 24. In each leg 30, the planar portions of the leg sections 24 abut each other. In this manner, each leg 30 has a substantially circular cross-section, as shown in FIG. 4. A plurality of bands are securely disposed around the leg sections 24 of each leg 30 so as to secure the leg sections 24 together and, thus, secure the frames 22 in the delta configuration. The bands are composed of a dielectric material, such as a dielectric plastic. In one embodiment, the bands are comprised of adhesive tape.

The coil assemblies 12 are mounted to and disposed around the legs 30, respectively. Each coil assembly 12 comprises a high voltage winding 32 and a low voltage winding 34, each of which is cylindrical in shape. If the transformer 10 is a step-down transformer, the high voltage winding 32 is the primary coil and the low voltage coil is the secondary coil. Alternatively, if the transformer 10 is a step-up transformer, the high voltage winding 32 is the secondary coil and the low voltage winding 34 is the primary coil. In each coil assembly 12, the high voltage winding 32 and the low voltage winding 34 are mounted concentrically, with the low voltage winding 34 being disposed within and radially inward from the high voltage winding 32, as shown in FIGS. 1 and 2. The high voltage winding 32 comprises a plurality of disc windings 60 that are connected in series. As will be described in more detail below, the disc windings 60 are formed from a conductor foil or strip in a winding operation.

The transformer 10 is a distribution transformer and has a kVA rating in a range of from about 112.5 kVA to about 15,000 kVA. The voltage of each high voltage winding 32 is in a range of from about 600 V to about 35 kV and the voltage of each low voltage coil is in a range of from about 120 V to about 15 kV.

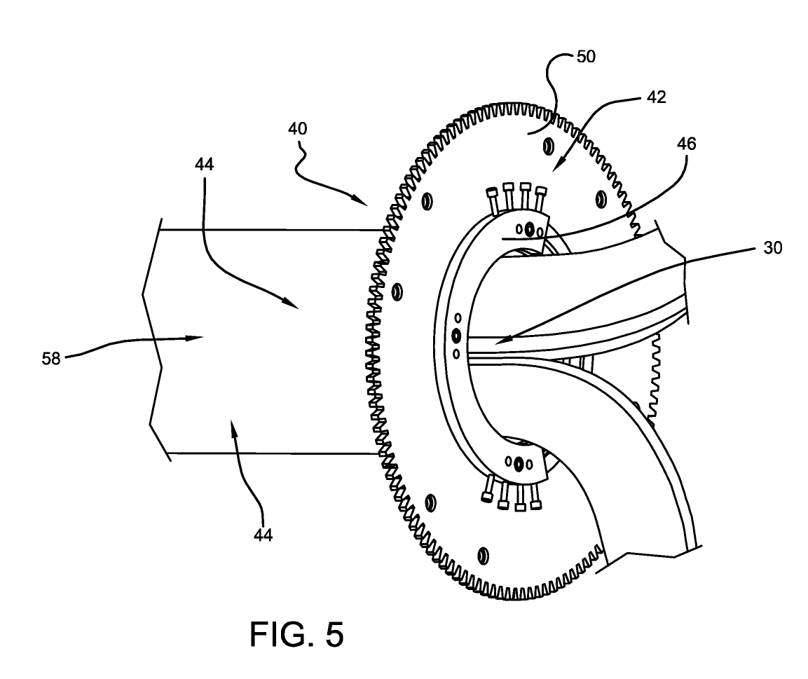

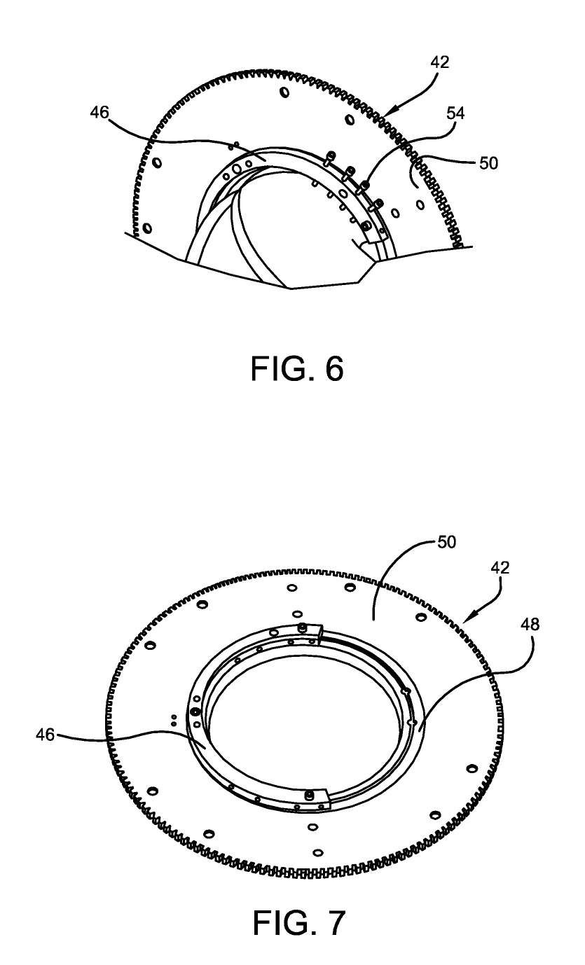

Referring now to FIG. 5, there is shown a portion of a winding device 40 attached to a leg 30 of the core 18. The winding device 40 is used to wind the low voltage winding 34 and the high voltage winding 32 of each coil assembly 12. The winding device 40 comprises a pair of gear assemblies 42 and a plurality of support plates 44. Each gear assembly 42 comprises a fixation ring 46, an orbital ring 48 and a gear baffle 50.

When a coil assembly 12 is to be wound on a leg 30, the gear assemblies 42 are mounted to the leg 30 in a spaced-apart manner, with one gear assembly 42 being mounted at a top end of the leg 30 (near the junction with the shoulder) and the other gear assembly 42 being mounted at a bottom end of the leg 30 (near the junction with the shoulder). The gear assembly 42 at each end of the leg 30 is constructed and mounted as described in the following paragraphs.

The fixation ring 46 is arcuate, having a circumference just over half a circle. A plurality of threaded bores are formed in the fixation ring and are adapted to threadably receive a plurality of securement screws 54. The fixation ring 46 is placed on the leg 30, toward the shoulder, and the securement screws 54 are threaded through the bores and into a wedging engagement with the leg 30, thereby securing the fixation ring 46 to the core 18.

The orbital ring 48 has two half circular sections that are secured together after they are placed on the leg 30. The orbital ring 48 is disposed inward from, but against the fixation ring 46 (toward the other orbital ring 48). The orbital ring 48 is secured to the fixation ring 46, such as by screws, and has a smooth outer circumferential surface that functions as a track, upon which the gear baffle 50 may rotate.

The gear baffle 50 has two sections, each with an arcuate inner edge and a toothed outer edge. The two sections of the gear baffle 50 are disposed over the orbital ring 48 such that their arcuate edges rest on the track of the orbital ring 48. The two sections are then secured together, thereby forming the gear baffle 50, which is disc-shaped and has an inner central opening and an outer circumferential edge with teeth. The gear baffle 50 also has an annular ledge (not shown) that protrudes from an inside surface of the baffle 50 and is located toward the inner central opening. The teeth of the gear baffle 50 may be engaged (meshed) with a drive gear (not shown) that is driven by an electric motor or other source of rotational force. Rotation of the drive gear causes the gear baffle 50 to rotate around the track of the orbital ring 48.

The support plates 44 are composed of a rigid material such as steel or a rigid plastic. Each support plate 44 extends between the gear baffles 50, with its ends being securely supported on the annular ledges of the gear baffles 50, respectively. The support plates 44 are curved and are arranged around the circumference of the leg 30 so as to form a cylindrical wall, which may be referred to as a low voltage (LV) mold 58. As described below, the low voltage winding 34 is formed upon the LV mold 58. In the shown embodiment, there are three support plates 44; however, a different number of support plates may be utilized, such as two or four. The LV mold 58 rotates with the gear baffles 50 when one or both of the gear baffles 50 is rotated by the drive gear(s).

The low voltage winding 34 may be formed from a continuous sheet of a conductor material and a continuous sheet of an insulation material. Alternatively, the low voltage winding 34 may be formed from an insulation-wrapped conducting wire. The conductor is composed of a conductive metal, such as copper or aluminum. In the embodiment where a sheet conductor is utilized, the conductor has a thickness of from about 0.2 to about 3 mm. The insulation sheet may be comprised of an aramid paper, such as is sold under the trademark Nomex®; a polyimide film, such as is sold under the trademark Kapton®, or a polyester film, such as is sold under the trademark Mylar®. Laminates formed by sandwiching different insulation materials like Nomex and Mylar or Dacron and Mylar can also be used. The conductor sheet and the insulation sheet are wound from a supply that dispenses the conductor sheet and the insulation sheet in an overlapping manner, with the conductor sheet being disposed over the insulation sheet. The supply may comprise one or more rotatable rolls of the conductor sheet and one or more rotatable rolls of the insulation sheet. The conductor sheet(s) and the insulation sheet(s) are wound onto the LV mold 58 through the rotation of the gear baffle(s) 50 and, thus, the LV mold 58. As the LV mold 58 rotates, the insulation sheet(s) and the conductor(s) are pulled from the source and wrapped around the LV mold 58 to form the low voltage winding 34 comprising a plurality of concentric turns or layers of the conductor sheet interleaved with a plurality of concentric turns or layers of the insulation sheet.

After the low voltage winding 34 has been formed, a high/low barrier is formed over the low voltage winding 34. The high/low barrier may be formed from a plurality of layers of the insulation sheet. In addition to, or in lieu of the layers of insulation sheet, one or more layers of a insulation material sheet may be used to form the high/low barrier. Alternatively, the high/low barrier may be formed after the high voltage winding 32 or both the high voltage winding 32 and the low voltage winding 34 have been encapsulated in polymeric material casing(s) during the molding process described below. In this embodiment, the high/low barrier is comprised of a plurality of sections that are secured together around the low voltage winding. The sections may be constructed of a relatively rigid dielectric plastic.

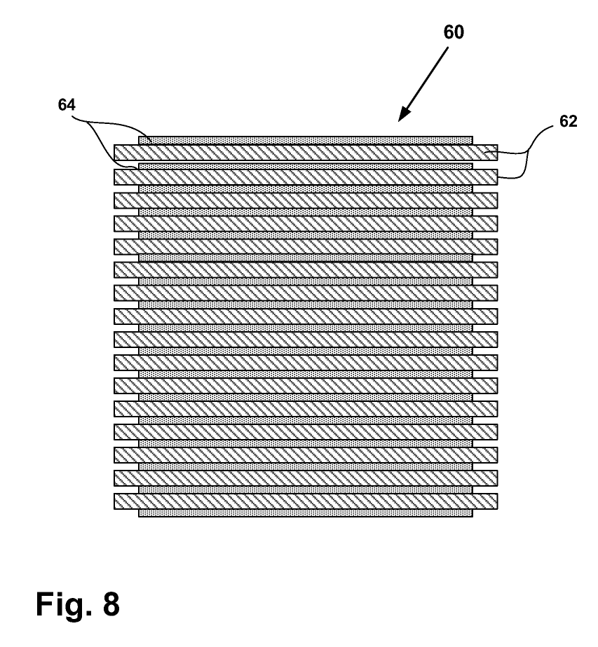

The high voltage winding 32 is formed over the high/low barrier. The high voltage winding 32 comprises a plurality of serially connected disc windings 60, each of which comprises a plurality of concentric turns or layers of a conductor strip 62 interleaved with a plurality of concentric turns or layers of an insulation strip 64, as shown in FIG. 8. The conductor strip 62 is comprised of a conductive metal, such as copper or aluminum, and has a width to thickness ratio of greater than 10:1, more particularly from about 400:1 to about 10:1, more particularly from about 100:1 to about 50:1. In one particular embodiment, the conductor strip is between about 0.2 to about 0.6 mm thick and between about 25 mm and 50 mm wide, more particularly about 0.25 mm thick and about 38 mm wide. The insulation strip 64 may be comprised of an aramid paper, such as is sold under the trademark Nomex®; a polyimide film, such as is sold under the trademark Kapton®, or a polyester film, such as is sold under the trademark Mylar® or other insulation films or laminate combinations. The width of the insulation strip 64 is dependent on the design of the high voltage winding 32. However, the insulation strip 64 is typically about 10 mm wider than the conductor strip 62. All of the disc windings 60 may be formed from a single length of the conductor strip. Alternatively, the disc windings 60 may be formed from separate lengths of the conductor strip 62, respectively, and then the disc windings 60 are connected together via welding or mechanical connectors.

The conductor strip 62 and the insulation strip 64 are wound into a disc winding 60 from a supply that dispenses the conductor strip 62 and the insulation strip 64 in an overlapping manner, with the conductor strip 62 being disposed over the insulation strip 64. The supply may comprise separate rolls of the conductor strip 62 and the insulation strip 64 that are dispensed from the supply separately. Alternatively, the conductor strip 62 and the insulation strip 64 may be secured together before they are dispensed from the supply. More specifically, the conductor strip 62 may be joined by adhesive to the insulation strip 64 to form a combined conductor/insulation strip that is stored in and dispensed from a single roll. The combined conductor/insulation strip may further be coated with a polymeric material, such as an epoxy, before the combined conductor/insulation strip is wound into the disc windings 60.

The conductor strip 62 and the insulation strip 64 are wound over the high/low barrier, which, together with the low voltage winding 34 are disposed over the LV mold 58. Alternatively, the conductor strip 62 and the insulation strip 64 may be wound onto another mold that is disposed over the high/low barrier. The conductor strip 62 and the insulation strip 64 are wound through the rotation of the gear baffle(s) 50 and, thus, the LV mold 58. As the LV mold 58 rotates, the conductor strip 62 and the insulation strip 64 are pulled from the source and wrapped around the high/low barrier to form a disc 60 comprising a plurality of concentric turns or layers of the conductor strip 62 interleaved with a plurality of concentric turns or layers of the insulation strip 64.

After a first disc winding 60 is formed, the rotation of the LV mold 58 is halted and the conductor strip 62 is prepared for the formation of a second disc winding 60. The preparation of the conductor strip 62 is dependent on how the disc windings 60 are wound and how they will be connected together. If the disc windings 60 are to be connected together by welding or a connector after the winding process is completed, the conductor strip 62 is cut after the first disc winding 60 is formed. If, however, the disc windings 60 are connected together by being formed from the same length of conductor strip 62, offset folds are formed in the conductor strip 62 after the first disc winding 60 is formed. The offset folds may comprise a pair of 45° angle folds that form an offset in the axial direction of the high voltage winding 32.

The above described steps are repeated until the requisite number of disc windings 60 are formed for a high voltage winding 32. The disc windings 60 can be wound in alternating directions, i.e., inside to outside and then outside to inside, etc. Alternatively, drop-downs can be provided so that the conductor strip 62 is wound in one direction, i.e., inside to outside. A drop-down is a bend that is formed at the completion of a disc winding 60 to bring the conductor strip 62 from the outside back to the inside to begin a subsequent disc winding 60.

The disc windings 60 may be wound from one end of the LV mold 58 to the other end of the LV mold 58 and in the same winding direction. Alternatively, the disc windings 60 may be wound in two sections, each starting from about the middle of the LV mold 58 and in opposite winding directions. The two sections may be connected in parallel.

In each high voltage winding 32, taps may be connected to junctures between the disc windings 60. These taps may be used to maintain constant voltage in the low voltage winding 34 associated with the high voltage winding 32. The taps may be connected to terminals 70 located on a dome 72 formed in the casing 14, as shown in FIG. 10. The taps may also be housed in top and bottom bushings 75, 77. An outer portion of the taps may extend slightly through an end surface of the top and bottom bushings 75, 77.

After the disc windings 60 have been formed and interconnected for each high voltage winding 32, the high voltage windings 32 are encased in the casings 14, respectively. Each casing 14 is formed from an insulating polymeric material, which may be an epoxy and, more particularly, an aromatic epoxy or a cycloaliphatic epoxy. In one embodiment, the epoxy is a cycloaliphatic epoxy, still more particularly a hydrophobic cycloaliphatic epoxy composition. Such an epoxy composition may comprise a cycloaliphatic epoxy, a curing agent, an accelerator and filler, such as silanised quartz powder, fused silica powder, or silanised fused silica powder. In one embodiment, the epoxy composition comprises from about 50-70% filler. The curing agent may be an anhydride, such as a linear aliphatic polymeric anhydride, or a cyclic carboxylic anhydride. The accelerator may be an amine, an acidic catalyst (such as stannous octoate), an imidazole, or a quaternary ammonium hydroxide or halide.

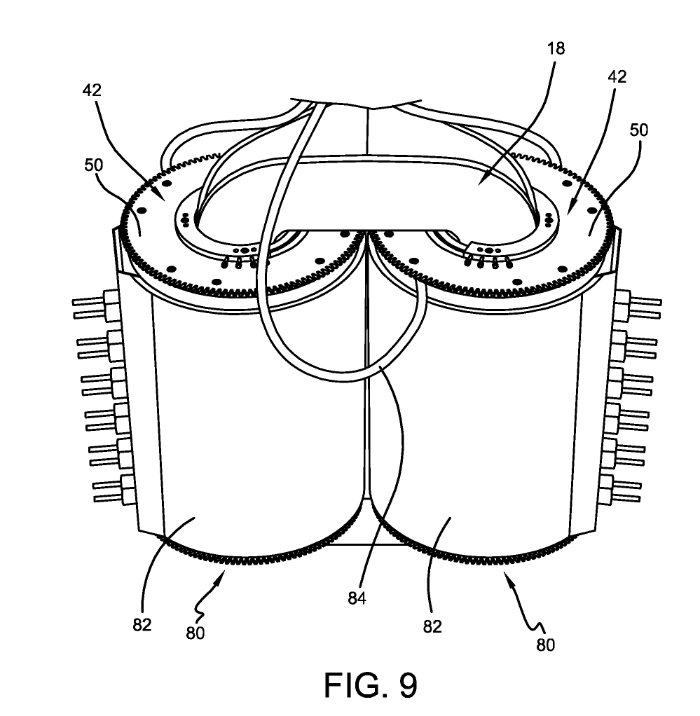

The casing 14 for each high voltage winding 32 may be formed using a casting mold 80 formed (in part) by the winding device 40. More specifically, the LV mold 58 forms an inner wall of the casting mold 80, while the gear baffles 50 form ends of the casting mold 80, as shown in FIG. 9. A multi-section sidewall 82 is formed around the high voltage winding 32 to complete the casting mold 80. A radial space is located between the sidewall 82 and the high voltage winding 32. During the casting process, the casting mold 80 and the high voltage winding 32 are positioned vertically and the insulating polymeric material is injected into a top of the casting mold 80 via tubes 84 that extend through a gap between an upper one of the gear baffles 50 and the sidewall of the casting mold 80.

The casting process may be an automatic pressure gelation (APG) process. In accordance with APG process, the polymeric material (in liquid form) is degassed and preheated to a temperature above 40° C., while under vacuum. The casting mold 80 may also be heated to an elevated curing temperature of the polymeric material. The degassed and preheated polymeric material is then introduced under slight pressure into the casting mold 80. Inside the casting mold 80, the polymeric material quickly starts to gel. The polymeric material in the casting mold 80, however, remains in contact with pressurized polymeric material being introduced from outside the casting mold 80. In this manner, the shrinkage of the gelled polymeric material in the casting mold 80 is compensated for by subsequent further addition of degassed and preheated polymeric material entering the casting mold 80 under pressure.

For each high voltage winding 32, after the polymeric material cures to a solid, the mold 80 is disassembled and removed. In particular, the sidewall 82 is first taken apart and removed. Then, the gear assemblies 42 (including the gear baffles 50) are disassembled and removed. Finally the LV mold 58 is removed, one support plate 44 at a time.

The low voltage windings 34 may also be encased in casings, respectively. These casings may be separate from the casings 14, but may be formed from substantially the same polymeric material in substantially the same manner as the casings 14, as described above. Alternatively, the low voltage windings 34 may not be encased in casings, but may, instead, simply be end-filled with a polymeric material.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A three-phase non-linear transformer, comprising:
a ferromagnetic core having three or more legs arranged in a non-linear configuration;
coil assemblies mounted to the legs, respectively, each of the coil assemblies comprising:
a low voltage winding; and
a high voltage winding comprising a plurality of serially-connected disc windings, each of the disc windings comprising alternating concentric layers of one or more conductor strips and one or more insulation strips, each conductor strip having a width to thickness ratio of greater than 10:1; and
a casing encapsulating the high voltage winding, the casing comprising a dielectric polymeric material.

2. The non-linear transformer of claim 1, wherein the legs of the core are arranged in a triangular configuration.

3. The non-linear transformer of claim 2, wherein the core comprises three frames, each having a closed or substantially closed periphery.

4. The non-linear transformer of claim 3, wherein each of the frames has a rounded rectangular shape has a pair of leg sections joined by shoulders to a pair of yoke sections, respectively.

5. The non-linear transformer of claim 4, wherein the frames are arranged in a triangular configuration such that the leg sections of each frame abut leg sections of the other two frames, respectively, thereby forming the three legs.

6. The non-linear transformer of claim 1, wherein each conductor strip is comprised of copper or aluminum.

7. The non-linear transformer of claim 1, wherein the disc windings of each high voltage winding are formed from a single length of conductor strip.

8. The non-linear transformer of claim 1, wherein each conductor strip is comprised of copper or aluminum and has a width to thickness ratio of from about 400:1 to about 10:1.

9. The non-linear transformer of claim 1, wherein the dielectric polymeric material is an epoxy.

10. The non-linear transformer of claim 9, wherein the dielectric polymeric material is a cycloaliphatic epoxy.

11. The non-linear transformer of claim 1, wherein the low voltage winding is encapsulated in a casing comprising a dielectric polymeric material.

12. The non-linear transformer of claim 1, wherein the low voltage winding comprises an insulated conductor with a rectangular cross-section.

13. A method of constructing a three-phase non-linear transformer, comprising:
(a.) providing a non-linear ferromagnetic core comprising a plurality of frames, each of which has a closed or substantially closed periphery, the frames being arranged to form at least three legs;
(b.) for each leg of the core, forming a low voltage winding around the leg;
(c.) forming a high voltage winding around each low voltage winding, wherein the forming of each high voltage winding around its associated low voltage winding comprises:
providing one or more insulation strips;
providing one or more conductor strips, each having a width to thickness ratio of greater than 10:1;
winding the one or more insulation strips and the one or more conductor strips around the low voltage winding to form a plurality of disc windings arranged in an axial direction of the low voltage winding, wherein each of the disc windings comprises alternating concentric layers of the one or more insulation strips and the one or more conductor strips; and
(d.) casting each high voltage winding in a dielectric polymeric material.

14. The method of claim 13, wherein the step of winding the one or more insulation strips and the step of winding the one or more conductor strips are performed simultaneously.

15. The method of claim 14, wherein the one or more insulation strips and the one or more conductor strips are secured together before the one or more insulation strips and the one or more conductor strips are wound around the low voltage coil.

16. The method of claim 13, wherein for each leg, the step of forming the low voltage winding comprises:
providing an insulation sheet;
providing a conductor sheet; and
winding the insulation sheet and the conductor sheet around the leg to form alternating concentric layers of the insulation sheet and the conductor sheet.

17. The method of claim 13, wherein each conductor strip is comprised of copper or aluminum.

18. The method of claim 13, wherein the disc windings of each high voltage winding are formed from a single length of conductor strip.

19. The method of claim 13, wherein each conductor strip is comprised of copper or aluminum and has a width to thickness ratio of from about 400:1 to about 10:1.

20. The method of claim 13, further comprising casting each low voltage winding in a dielectric polymeric material.

21. The method of claim 13, wherein for each leg, the step of forming the low voltage winding comprises:
providing an insulated conductor with rectangular cross-section; and
winding the conductor around the leg to form one or more concentric layers of the conductor.
